(19) United States
(12) Patent Application Publication
(10) Pub. No.: US 2014/0279188 A1
(43) Pub. Date: Sep. 18, 2014

(54) SYSTEMS AND METHODS FOR PROVIDING QUANTITIES OF PREVIOUSLY ORDERED PRODUCT TO REPEAT USERS OF A WEBSITE

(71) Applicant: W.W. GRAINGER, INC., Lake Forest, IL (US)

(72) Inventors: David Brett Powell, Haubstadt, IN (US); Geoffry A. Westphal, Evanston, IL (US)

(21) Appl. No.: 13/801,481

(22) Filed: Mar. 13, 2013

(51) Int. Cl. G06Q 30/06

(52) U.S. Cl. CPC G06Q 30/0631
USPC 705/26.7

(57) ABSTRACT

A system can store a wide variety of information regarding a user's interactions with a website in a first web browsing session. In particular, the information may include a quantity of a product that the user ordered in the first web browsing session. When the user returns to the website to reorder the product in a second web browsing session, the system may display the quantity of the product that the user previously ordered without requiring the user to navigate to and review an order history webpage. The system may display such information regarding the quantity of previously ordered product in a user interface element that appears next to a quantity input box associated with the product.

### FIELD OF DISCLOSURE

The present disclosure relates generally to e-commerce and, more particularly, to systems and methods for providing quantities of previously ordered product to repeat users of a website.

### BACKGROUND

In the art it is known to monitor interactions of a user with a website. For example, U.S. Pat. No. 6,877,007 to Hentzel et al. entitled, “METHOD AND APPARATUS FOR TRACKING A USER'S INTERACTION WITH A RESOURCE SUPPLIED BY A SERVER COMPUTER,” which is incorporated herein by reference in its entirety, describes a system and method that tracks interactions of a user with content provided by a website. To this end, input made by a user as the user interacts with at least one webpage that comprises the website, such as mouse movements, button clicks, typing, etc., is streamed back to a tracking server and stored.

Further, one piece of information that both business-to-business and business-to-consumer websites often store is quantity of products that the user orders. Upon returning to a vendor's website to reorder products that have previously been ordered, the user may appreciate reviewing a quantity or quantities of product that the user ordered in the past. The problem, however, is that to view such quantities, the user must oftentimes review personal electronic or paper records or navigate to an order history webpage on the vendor's website and then search for the information. In short, despite the existence of sophisticated website tracking techniques, quantities of previously ordered product are not readily available to users that reorder products from websites.

### BRIEF DESCRIPTION OF THE DRAWINGS

For a better understanding of the disclosed systems and methods for providing quantities of previously ordered product to repeat users of a website, reference may be had to examples shown in the following drawings.

FIG. 1 is a block diagram illustrating components of an example network system in which the disclosed systems may be employed.

FIG. 2 illustrates an example webpage of an example website in which a user may schedule automated recurring orders of a product.

FIG. 3 illustrates an example webpage of an example website in which an example user interface element shows quantities of a product that have been ordered previously.

FIG. 4 illustrates an example webpage of an example website in which an example user interface element in the form of a calendar shows quantities of a product that have been ordered previously.

FIG. 5 illustrates an example webpage of an example website in which an example user interface element in the form of a bar graph shows quantities of a product that have been ordered previously.

FIG. 6 illustrates an example webpage of an example website in which an icon next to a quantity input box indicates to a user that a product has been ordered previously.

FIG. 7 illustrates the webpage of FIG. 6 in which another example user interface element shows quantities of the product that have been ordered previously.

### DETAILED DESCRIPTION

To address the aforementioned need and other needs, disclosed hereinafter are systems and methods that use information gained from monitoring interactions of a user with a website to enhance subsequent website visits by the user. By storing data about the interactions of the user with the website, order quantities from prior browsing sessions can later be retrieved and presented to the user when the user returns to the website. Such data can be stored locally on the user device or remotely on a server, for example. The data can be specific to a particular user, cookie, user processing device, corporate account, etc. Upon viewing a webpage having information about a product that was previously ordered, the system may display quantities and dates associated with the user's prior orders of that product. In some examples, the quantities and dates may be displayed on the webpage without any further user interaction. In other examples, however, the quantities and dates may be displayed when the user clicks or mouses over the quantity input box, an add-to-cart button associated with that product, a brief description of the product, or an image of the product.

The quantities and dates may be displayed in a user interface element that appears near the quantity input box. The user interface element may contain a bar graph, a timeline, a calendar, a list, and/or the like in some instances. The user interface element may further contain a statistic based on the quantities and dates of order. In some examples, the user interface element may be part of a header, a footer, a sidebar, or a popup box. Further yet, in some examples, the user interface element may only be displayed for a period of time unless the user selects or mouses over the user interface element before it fades away. Displaying quantities and dates of prior orders may be particularly advantageous in product searches, in keyword searches, in webpages constituting part of a checkout process, in lists of frequently or recently ordered products, in personal lists, and/or any page that contains the quantity input box associated with the product that was previously ordered. In short, the disclosed system makes such information available to the user without requiring the user to navigate to an order history page or some other part of a website.

While the foregoing generally disclose systems and methods for providing previous order quantities to repeat users of a website, a better understanding of the objects, advantages, features, properties, and relationships of the systems will be obtained from the following detailed description and accompanying drawings, which set forth illustrative examples that are indicative of the various ways in which the principles of the disclosure may be employed.

With reference now to the figures, the following discloses example systems for providing previously ordered quantities of product to repeat users of a website. Example users of the website include without limitation, customers, customer service representatives, authorized members of corporate accounts, and so on. As illustrated in FIG. 1, a system 10 will be described in the context of a plurality of processing devices linked via a network 12, such as the World Wide Web or the Internet. In this regard, a user processing device 20, illustrated in the example form of a computer system, a user processing device 20′, illustrated in the example form of a mobile device, or a user processing device 20″, illustrated in the example form of a personal computer, provide a means for a user to access a website content server 68 via the network 12 and thereby gain access to content such as media, data, webpages, an electronic catalog, etc., stored in a repository 68A associated with the content server 68. Furthermore, the website content server 68 and/or the user devices 20, 20′, 20″ include functionality that allows the system 10 to monitor how a user interacts with the website content offered via the website content server 68.

By way of non-limiting example, the system 10 monitors user interactions with a website during web browsing sessions by recording events, accessed content, and other data such as the following: keyword searches; model number searches; stock-keeping unit (SKU) searches; selection guides; clicked links; links that a user's mouse hovered over for a measurable period of time; accessed menus; products viewed; number of products reviewed; product images that were magnified; product comparisons; times during which webpages or other content was viewed or accessed; duration of stay; dialogs of chat sessions; audio recordings of telephonic conversations between the user and a customer service representative; identities of employees with which the user interacts; notes from users, peers (e.g., another company employee or an employee from another company), service representatives, or technical representatives; lists of products generated by users; order histories; quantities of each product ordered; pending orders; user alerts; user preferences; personal information (e.g., created by or provided for the user); information that is related to the user via the user's membership in a group; referring websites; transfer websites; and so on. In short, the systems may in some examples record virtually all aspects regarding a user's visit to the website.

A web browsing session may, for example only, correspond to a timeframe during which a user is interacting with a website. Put one way, a browsing session may commence when a user loads a webpage of a website and may terminate when the user logs-out of the website. Depending on how the website and/or the user's web browser are configured, the system 10 may log-out the user after a period of inactivity (e.g., a “time-out”), after the user closes a tab or web browser with the website, or after the user has requested for the system 10 to log-out the user. Thus a user browsing a website could potentially participate in a number of sessions in the same day.

Further, to enhance the user's next visit to the website, such information relevant to the user's interactions with the content offered by the website content server 68 are stored, and certain aspects of such information are provided to the user when the user returns to the website in one or more subsequent web browsing sessions. In one example, information relevant to the user's interactions with the content offered by the website are stored in the repository 68A associated with the content server 68 and are further indexed to a particular user (e.g., using log-in information or other information that the content server 68 may utilize to identify the user). The system may then retrieve such information when the system identifies the user during subsequent web browsing sessions (e.g., by receiving a valid user name/password credentials, by recognizing an IP address, by utilizing cookies stored locally on the user's processing device 20, etc.).

In another example, the information relevant to the user's interactions with the content offered by the website may also or alternatively be stored on the user computing device 20 and/or other storage media local to the device 20, for example, in cases where a user has not logged onto the website content server 68 and is anonymously navigating the content provided by the website content server 68. In such cases, the information relevant to the user's interactions with the content offered by the website content server 68 may be stored in, for example, a cookie placed onto the user computing device 20 and/or other storage devices using well known techniques. Because the manner by which the user device 20 is used to access and navigate the website offered by the website content server 68, the manner by which the website content server 68 makes content available to the user device 20, and the manner by which the website usage is monitored are all well known in the art, they will not be discussed herein for the sake of brevity.

For performing the functions required of the computing devices 20 and 68, the computing devices include computer executable instructions that reside in program modules that may include routines, programs, objects, components, data structures, etc. that perform particular tasks or implement particular abstract data types. Accordingly, one of ordinary skill in the art will appreciate that the computing devices may be any device having the ability to execute instructions such as, by way of example, a personal computer, mainframe computer, personal-digital assistant (“PDA”), tablet, cellular telephone, mobile device, e-reader, or the like. Furthermore, while the computing devices within the system are illustrated as respective single devices, those having ordinary skill in the art will also appreciate that the various tasks described hereinafter may be practiced in a distributed environment having multiple processing devices linked via a local or wide-area network whereby the executable instructions may be associated with and/or executed by one or more of multiple processing devices.

More particularly, the user computing device 20, which may be representative of all of the computing devices illustrated in FIG. 1, performs various tasks in accordance with the executable instructions. Thus the example user computing device 20 includes one or more processing units 22 and a system memory 24, which may be linked via a bus 26. Without limitation, the bus 26 may be a memory bus, a peripheral bus, and/or a local bus using any of a variety of bus architectures. As needed for any particular purpose, the example system memory 24 includes read only memory (ROM) 28 and/or random access memory (RAM) 30. Additional memory devices may also be made accessible to the processing device 20 by means of, for example, a hard disk drive interface 32, a removable magnetic disk drive interface 34, and/or an optical disk drive interface 36. As will be understood, these devices, which would be linked to the system bus 26, respectively allow for reading from and writing to a hard disk 38, reading from or writing to a removable magnetic disk 40, and for reading from or writing to a removable optical disk 42, such as a CD/DVD ROM or other optical media. The drive interfaces and their associated tangible, computer-readable media allow for the nonvolatile storage of computer readable instructions, data structures, program modules and other data for the user computing device 20. Those of ordinary skill in the art will further appreciate that other types of tangible, computer readable media that can store data may be used for this same purpose. Examples of such media devices include, but are not limited to, magnetic cassettes, flash memory cards, digital videodisks, Bernoulli cartridges, random access memories, nano-drives, memory sticks, and other read/write and/or read-only memories.

A number of program modules may be stored in one or more of the memory/media devices. For example, a basic input/output system (BIOS) 44, containing the basic routines that help to transfer information between elements within the user computing device 20, such as during start-up, may be stored in ROM 28. Similarly, the RAM 30, hard drive 38, and/or peripheral memory devices may be used to store computer executable instructions comprising an operating system 46, one or more applications programs 48 (such as a Web browser), other program modules 50, and/or program data 52. Still further, computer-executable instructions may be downloaded to one or more of the computing devices as needed, for example, via a network connection.

A user may enter commands and information into the user computing device 20 through input devices such as a keyboard 54 and/or a pointing device 56. While not illustrated, other input devices may include a microphone, a joystick, a game pad, a scanner, a touchpad, a touch screen, a motion sensing input, etc. These and other input devices would typically be connected to the processing unit 22 by means of an interface 58 which, in turn, would be coupled to the bus 26. Input devices may be connected to the processor 22 using interfaces such as, for example, a parallel port, game port, firewire, universal serial bus (USB), or the like. To receive information from the user computing device 20, a monitor 60 or other type of display device may also be connected to the bus 26 via an interface, such as a video adapter 62. In addition to the monitor 60, the user computing device 20 may also include other peripheral output devices such as a speaker 53.

As further illustrated in FIG. 1, the user computing device 20 has logical connections to one or more remote computing devices, such as the content server 68 which, as noted above, may include many or all of the elements described above relative to the user computing device 20 as needed for performing its assigned tasks. By way of further example, the website content server 68 may include executable instructions stored on a non-transient memory device for, among other things, presenting webpages, handling search requests, providing search results, providing access to context related services, sending emails, managing lists, managing shopping carts, presenting requested user specific information, etc. Communications between the user computing device 20 and the content server 68 may be exchanged via a further processing device, such as network router 72, that is responsible for network routing. Communications with the network router 72 may be performed via a network interface component 73. Thus, within such a networked environment, e.g., the Internet, World Wide Web. LAN, or other like type of wired or wireless network, it will be appreciated that program modules depicted relative to the user computing device 20, or portions thereof, may be stored in the memory storage device(s) of the content server 68. Additionally, it will be understood that, in certain circumstances, various data of the application and/or data utilized by the content server 68 and/or user computing device 20 may reside in the “cloud” or other suitable distributed storage mediums.

As briefly described above, the information gathered from the website usage monitoring may then be used to supplement web content offered by the content server 68. When an event occurs where such data must be retrieved, as described below, the data repositories 68A may be accessed to thereby extract relevant data from the data repositories 68A.

One category of measured data with which this disclosure is concerned includes data pertaining to quantities of previously ordered product. While described in the present disclosure as including previous orders that may have been placed via the website, one of ordinary skill in the art will appreciate previous orders placed by phone, by mail, etc. A variety of advantages flow from allowing a user to review quantities of product that the user ordered in the past. For instance, reviewing prior order quantities for a specific product provides reference points that allow the user to make a more-informed decision, which in turn enhances the user's confidence for placing orders, improves customer accuracy, and enhances customer satisfaction. Quantities of previously ordered product may also help the user order a sufficient quantity of product while minimizing surplus.

Still further advantages, however, become apparent when quantities of previously ordered product are made readily available to the user through little to no effort from the user. One of the foremost advantages, for purposes of example only, is that the user will actually review the quantities of previously ordered product and consider such quantities when placing orders. As described below, the present disclosure eliminates the need for the user to check personal records, to locate and navigate to an order history section of a website, to search through prior order history logs for records pertaining to a particular product, and/or the like as part of an effort to view quantities of previously ordered product. In other words, although order histories may be available in portions of other websites, users of those websites either do not access those histories or are inconvenienced by having to seek out those order histories when reordering a product. Still another advantage of providing quantities of previously ordered product in a readily-available format is that the quantities will, in time, cause the user to hone in on an appropriate order quantity.

Because users may find a wide variety of content pertaining to quantities of previously ordered product to be helpful in a number of different contexts, in at least one example the present disclosure makes a breadth of content available to users at a multitude of different webpages within the website. For instance, when a user returns to the website, data stored from one or more prior browsing sessions may be retrieved so that the website can display content on various webpages used by the user. The content, as detailed below, can be displayed on webpages that contain any information about a product that was previously ordered. Such information may range, for example, from a name of the product to a product specification page with full details. Before disclosing example contexts and example user interface elements through which the content may be displayed, however, some example content pertaining to quantities of previously ordered product will be disclosed.

In some examples, the website displays one or more quantities of product that were previously ordered. The website may also display the date and/or a representation thereof on which the user ordered each quantity of product. Further, the website may generally organize the displayed quantities by product list, relevance, or any other suitable organization method. So the website may display, for instance, those quantities that pertain to a product of present interest to the user. Depending on the form in which the data is displayed, a timeframe from which the quantities of previously ordered product are shown may vary depending on frequency and/or dates of the user's orders. If, for example, the user ordered hex-head two-inch bolts on seven occasions over the last two months and on two occasions three years ago, the timeframe may pertain only to the last two months where the data is shown in the form of a timeline. By contrast, if the data is shown in a list form, the website would likely display all of the occasions where the user placed an order for this product.

The website may also display statistics associated with the quantities of previously ordered product in some examples. For example and without limitation, the website may display an average number of hex-head two-inch bolts per month that the user has ordered. Or if past orders occurred more frequently, the statistic may be on a per week basis, for example. By way of further example, the website may display an average or median quantity per order for a certain product, and/or an average or median number of days, weeks, months, or years between the user's orders for the product. Such example statistics may be particularly advantageous where a user desires to setup an automated recurring order schedule for the product.

What's more, the website and/or the user may eliminate certain extraneous data points. To illustrate, consider a corporate account that consistently orders between 205 and 245 hex-head two-inch bolts per month from the website over the last three years, but on seven occasions within those three years a user of the corporate account ordered single digit quantities of hex-head two-inch bolts. These seven quantities are not representative of the corporation's needs, yet those statistics might otherwise be factored into statistics pertaining to the corporation's orders of hex-head two-inch bolts. Using mathematical equations known in the art involving standard deviations, for instance, the website may identify and eliminate these extraneous statistics so as to prevent them from skewing the corporation's statistics. In the alternative or in addition, an authorized user of the corporate account may either initiate or confirm the removal of such unrepresentative statistics. This feature may also be advantageous when a user's needs change for any reason.

Moreover, the website's ability to show quantities of previously ordered product can serve as an audit tool, for both individual and corporate users as well as the vendor/website operator (e.g., to spot unusual activity and act accordingly). For example, users may be able to compare quantities of a product ordered on particular dates to the user's inventory of that product in the past. As a further example, users may utilize the website's ability to show previously ordered product quantities to verify numbers in a company's product management system or the like. Having the ability to view quantities of previously ordered product may also help a user identify, for example, reasons for surplus product, inconsistencies in order histories, and anomalies in order history to name a few.

All of this example web content pertaining to quantities of previously ordered product, which can be rendered based on data retrieved from the data repositories 68A, may be presented to the user in, for example, a popup, an expansion box, a calendar, a sidebar, a header, a footer, and/or any other user interface element associated with a webpage. Such user interface elements may be displayed, for example, when the user clicks or hovers the mouse over a quantity input box or a button that adds the product to an electronic cart. However, these user interface elements may also be displayed automatically, as soon as the user navigates to a webpage that contains information about a previously ordered product. In some examples, the website may only display a user interface element for a limited amount of time, such as five seconds, for instance, before the user interface element begins to fade away. If a user directs the mouse over the user interface element within that limited amount of time or before the user interface element fades away completely, the website may redisplay the user interface element in full. At the same time, the website may reset the amount of time until the user interface element again fades away. In another example, the website may redisplay a user interface element in full where the user moves the mouse towards a partially-faded user interface element. In still another example, the website may require the user to click on a user interface element or partially-faded user interface element to maintain the user interface element on the screen. In yet other examples, the website may display numerous user interface elements at one time. The website may slowly fade the user interface elements, except for those that the user hovers the mouse over or clicks on. Another example involves the website fading the user interface element as soon as the user exhibits a lack of interest in the user interface element, such as by scrolling up/down the webpage or clicking an unrelated hyperlink, for instance.

While the present disclosure concerns providing web content pertaining to quantities of previously ordered product with little to no user effort, the present disclosure also contemplates that the website can make such web content available where the user seeks such web content by clicking a link in a header, a footer, a sidebar, and/or the like. Further, a variety of programming languages, including standard HTML, for example, allow for the modification of webpage content such as adding user interface elements. Those having ordinary skill in the art will readily appreciate how to use standard HTML programming and/or other programming languages to display user interface elements to a webpage based on a user's present and past interactions with a website.

With reference again to the figures, example webpages are shown in FIGS. 2-5 and FIGS. 6-7, some of which illustrate quantities of previously ordered product, or at least content pertaining thereto. More particularly, FIGS. 2-5 are shown in the context of a checkout process on a website, and FIGS. 6-7 are shown in the context of a search process on a website. As disclosed above, though, the quantities of previously ordered product may be displayed in a wide variety of contexts, including in keyword searches, parametric searches, order histories, homepages, lists of frequently or recently ordered products, personal lists, and interactive shopping carts, for example and without limitation.

With reference to the example of FIG. 2 specifically, a webpage 100 shows an example order form 104 that is displayed as part of a checkout process on a website. The order form 104 shows information pertaining to a coffee can 106 that a user has placed in an electronic cart. This information includes, for example, an item number 108, a description 110, a model number 112, a shipment quantity 114, availability 116, a price 118, and an extended price 120. The order form 104 further includes a quantity input box 122 in which the user can enter a desired number of coffee cans 106 that the user would like to order. Near the example quantity input box 122, a user interface element 124 permits the user to schedule automated recurring orders on a periodic basis. For example, the user may schedule automated recurring orders of the coffee can 106 every two months. Although the period shown here is in terms of months, the user interface element 124 may allow the user to modify the period such that the user could schedule reorders of the coffee can 106 every three weeks or five days, for instance.

One having ordinary skill in the art will appreciate that even though a user interface element that displays a quantity corresponding to a prior order of the coffee can 106 is not shown, the webpage 100 could display this type of user interface element in addition or in the alternative to the user interface element 124. Thus based on the example shown in FIG. 2, it is likely that either the webpage 100 has not yet identified the user or this is the first time this particular user has ordered this type of coffee can 106. However, the present disclosure also contemplates that quantities of previously ordered product may be displayed based on products of a similar type. In the example shown in FIG. 2, for instance, a previously ordered quantity may be shown that pertains to another brand of coffee of a similar size. Where quantities are displayed based on products of a similar type, the website may display an alert, a symbol, colored text, and/or any other form of notice that draws the user's attention to the fact that the displayed quantity is based on a different product.

Once an automated recurring order has been scheduled, the website may in one example allow the user to enter a quantity of product that the user has inventoried. The website may automatically, or at least provide the user with an option to, then subtract and/or confirm that quantity of product—or a subset of that quantity of product—from the next scheduled order. A subset may be used because the user may wish to have some minimum quantity of product on hand at all times. Likewise, if the user later enters a lower quantity of product inventoried before the next scheduled order, the website may automatically, or at least provide the user with an option to, then recalculate and/or confirm the quantity of product needed for the next scheduled order.

With reference now to FIG. 3, the webpage 100 indicates that the user has placed the same product, namely the coffee can 106, in the electronic cart. Based on previously ordered quantities of this product, the website 100 has displayed the user interface element 102 to provide a reference for the user. The example user interface element 102 displays quantities 150 of this product that have been previously ordered, dates 152 on which the quantities 150 were ordered, and notes and identities 154 of those who previously ordered the product. The quantities 150 may be sorted in chronological order, in reverse chronological order, by quantity, and/or by purchaser, for example. Further, the notes and identities 154 may in other examples be separate columns. The user interface element 102 displays identities of various purchasers because in this example these purchasers are members of a corporate account. As shown in the user interface element 102, Randi ordered two of the coffee cans 106 on Jul. 4, 2012, for a Fourth of July party. As will be appreciated, the notes 154 may be helpful for a variety of reasons including, for example, helping to explain why a certain quantity was ordered and/or how a certain quantity of product was allocated. Here, the instant user can discern from Randi's notes that the order of two of the coffee cans 106 from Jul. 4, 2012, was for purposes other than day-to-day needs, and that typically in the past only one of the coffee cans 106 has been ordered.

Although not shown, it will be further appreciated that other types of data may be displayed on the user interface element 102. For instance, the user interface element 102 may display a statistic based on previously ordered quantities of product. With respect to FIG. 3, for example, the statistic may indicate that the corporation orders one of the coffee cans 106 approximately every three and a half weeks. Further, this statistic could be modified if the website or the user were to discard the quantity associated with the Fourth of July party.

Turning to FIG. 4, the webpage 100 displays the order form 104 with another example user interface element 102. In this example, the user interface element 102 is a calendar 200 that displays quantities of previously ordered product 202. A user can click backward arrows 204 and forward arrows 206 to select months of interest. As disclosed above, if the user desires to view more information about a particular order, the user may click any of the quantities of previously ordered product 202, which will prompt the website to display information relevant to that order. This feature, as with most or all of the features disclosed, may be provided with the other example user interface elements as well.

The webpage 100 may also provide tools with which to filter the quantities of previously ordered product 202 displayed on the calendar 200. For example, the webpage 100 may allow a user associated with a corporate account to filter the quantities of previously ordered product 202 based, for instance, on who ordered the product, an amount of the total order, time of day of the order, and the like. Further, the calendar 200 can be resized so that the user can view more or less months.

Still further, during the display of these user interface elements 102 and/or other web content, the user may wish to see further information regarding a particular quantity, for example. Those having ordinary skill in the art will appreciate that the previously ordered quantities of product 202 may be associated with other data stored in the repository 68A. At the user's request, the website may retrieve this data and render web content based on this data for display. Thus the webpage 100 may display information associated with one of the previously ordered product quantities 202 when the user mouses over the previously ordered product quantity 202. Such information may include without limitation specifics of that particular order, any notes recorded with that order, any customer service representative that assisted with that order, the time and date of that order (if not already displayed), other products that were ordered as part of that order, other products that have been ordered with that product in still other orders, the user (for purposes of corporate accounts) that placed the order, and so on. In other contexts, for example, if the user selects or mouses over a data point on a timeline representing a previously ordered quantity, the website may display further information as to that previously ordered quantity.

Yet another example way of displaying quantities of a previously ordered product is shown in the user interface element 102 in FIG. 5. The example user interface element 102-displays a chart 230 that depicts quantities 232 of a previously ordered product, here the coffee can 106, by dates 234. Similar to the example user interface element in FIG. 3, the user interface element 102 of FIG. 5 may be sorted in chronological order, in reverse chronological order, by quantity, and/or by purchaser, for example. As with the other example user interface elements, the quantities 232 may be filtered and/or more information associated with the quantities 232 may be displayed at the user's discretion.

As described above, quantities of previously ordered product may also be helpful to users browsing other parts of the website. Therefore, the website may also display quantities of previously ordered product in keyword searches, parametric searches, order histories, homepages, lists of frequently or recently ordered products, personal lists, and interactive shopping carts, for example. As shown in FIG. 6, another example webpage 270 displays web content regarding hex head cap screws. In particular, the webpage 270 shows that 7,373 different hex head cap screws are available for order. A brief description of each product 272 may contain a variety of information including a quantity input box 274. The quantity input box 274 allows users to enter a quantity of the product that they would like to order. However, before entering a quantity, a user must identify particular products of interest. One example way to filter the results is by using refinement tools 276 to eliminate categories and types of product that are not of interest. Even after a user narrows the product result list, though, the user may still not be able to readily identify which product or products have been previously ordered. One way to identify such products is to filter or sort the results by those that were “previously ordered.”

With continued reference to FIG. 6, another example way to help identify such products is by an icon 278, which may be displayed on the webpage 270 to identify those products that the user has previously ordered. Thus a user viewing the webpage 270 would know that the user, or alternatively, another user on a shared corporate account, network, computer, etc., ordered item number 2CA54 corresponding to a particular type of hex cap screw.

Further, by clicking on or mousing over the icon 278, the webpage 270 may display a user interface element 300 such as that shown in FIG. 7. The example user interface element 300 shows information pertaining to quantities 302 of product that were previously ordered, the dates 304 on which those quantities 302 were ordered, and notes and identities 306 of purchasers. The identities 306 may be relevant for corporate accounts. Moreover, the example user interface element 300 may function similar to the user interface element shown in FIG. 3. In addition, the example webpage 270 includes the user interface element 124 that permits the user to schedule automated recurring orders on a periodic basis, as described above with respect to FIG. 2.

As illustrated in the figures, many webpages of the website include a quantity input box associated with a product. For products that the user has not ordered in the past, the number, if any, in the quantity input box is typically one. For products that the user has in fact ordered in the past, however, the website may indicate within the quantity input box a number that represents the quantity of product that was ordered most recently. This number in the quantity input box may be in addition or in the alternative to a user interface element that displays information regarding the quantities of recently ordered product. Likewise, this number in the quantity input box may be in addition or in the alternative to an icon that indicates that the user has previously ordered a certain product. In still other examples, the number in the quantity input box may represent an average or median quantity of product that is ordered according to the user's order history. In yet a further example, the number in the quantity input box may represent a maximum quantity of product that has been ordered in the past.

Also, the website may display additional web content pertaining to quantities of previously ordered product in some examples. For instance, a sidebar, a header, a footer, a ribbon, or any other part of a webpage may contain a summary display that shows quantities of product for the most recent orders or a category of product orders. Thus quantities can be shown for a variety of products, and products can be identified by names, brief descriptions, product categories, SKU numbers, dates of orders, and/or images of the product. The summary display could include text, a scroll bar, graphics such as a timeline or a bar graph, andor the like. Further, the summary display may include buttons that would allow the user to filter the content displayed in the summary display. By way of example and without limitation, the filter buttons, tabs, or the like allow the user to filter content by purchaser identity (for corporate accounts), type or category of product, cost of product, quantity of product, dates or date ranges of prior orders, personal lists, and/or SKU numbers. The content shown in the summary display could likewise be sorted in similar fashion. Yet further, still other content as described above (e.g., statistics based on quantities of previously ordered product) may be provided in the summary display as well.

Another example context in which the summary display could be used is with lists of frequently ordered products, lists of recently ordered products, or personal lists. The first two are self-explanatory, but an example personal list is a list of products that a user creates for a specific application, project, and/or purpose. For instance, if the user needs thirteen products each time a boiler is cleaned, the user may generate a personal list through the website that itemizes these thirteen products. The list may contain names of the products, brief descriptions of the products, images of the products, SKUs for the products, sizes, and/or any notes associated with the products, for example only. On a webpage displaying the personal list, quantity input boxes may be associated with each product in the list. To assist the user in determining a quantity needed for each product on the list, the webpage may also include a summary display, as described above, which provides content including quantities of products on the list that were previously ordered. In the alternative or in addition, a number within each quantity input box may be equal to a quantity of product that was most-recently ordered, as disclosed above.

While various concepts have been described in detail, it will be appreciated by those of ordinary skill in the art that various modifications and alternatives to those concepts could be developed in light of the overall teachings of the disclosure. For example, while various aspects of the present disclosure have been described in the context of functional modules and illustrated using block diagram format, it is to be understood that, unless otherwise stated to the contrary, one or more of the described functions and/or features may be integrated in a single physical device and/or a software module, or one or more functions and/or features may be implemented in separate physical devices or software modules. It will also be appreciated that a detailed discussion of the actual implementation of each aspect of the disclosure is not necessary for an enabling understanding of the disclosure. Rather, the actual implementation of the systems and methods would be well within one of ordinary skill in the art, given the disclosure herein of the attributes, functionality, and inter-relationship of the various components in the system. Therefore, a person of ordinary skill in the art will be able to practice the disclosure set forth in the claims without undue experimentation. It will be additionally appreciated that the particular concepts disclosed are meant to be illustrative only and not limiting as to the scope of the disclosure which is to be given the full breadth of the appended claims and any equivalents thereof.

We claim:

1. A non-transitory computer readable media having stored thereon instructions which, when executed by a computer, perform steps comprising:
storing a quantity of a product that a user orders through an electronic commerce website in a first web browsing session;
displaying in a second web browsing session a webpage of the electronic commerce website that has at least some information regarding the product; and
displaying on the webpage the quantity of the product that the user ordered during the first web browsing session, wherein the webpage includes a quantity input box in which the user can specify a quantity of the product that the user would like to order.

2. A non-transitory computer readable media as recited in claim 1, wherein the quantity of the product displayed on the webpage is shown in a user interface element located next to a quantity input box.

3. A non-transitory computer readable media as recited in claim 2, wherein the user interface element appears as a user clicks or hovers a computer mouse over at least one of the quantity input box, a button that adds the product to an electronic cart, or an icon that indicates that the user has previously ordered the product.

4. A non-transitory computer readable media as recited in claim 2, wherein the user interface element displays a date on which the product was ordered.

5. A non-transitory computer readable media as recited in claim 2, further comprising storing an additional quantity of the product that the user orders after the first web browsing session and prior to the second web browsing session, further comprising displaying a statistic in the user interface element based on the quantity, the additional quantity, and dates on which the products were ordered.

6. A non-transitory computer readable media as recited in claim 2, wherein a number in the quantity input box in the second web browsing session is based on the quantity of the product ordered during the first web browsing session.

7. A non-transitory computer readable media as recited in claim 2, wherein the user interface element contains at least one of a timeline or a bar graph.

8. A non-transitory computer readable media as recited in claim 1, wherein the webpage is not an order history webpage.

9. A non-transitory computer readable media as recited in claim 1, further comprising displaying on the webpage in the second web browsing session a user interface element that permits the user to schedule automated recurring orders on a periodic basis.

10. A non-transitory computer readable media as recited in claim 1, wherein the quantity displayed on the webpage can be selected to display information about the order.

11. A non-transitory computer readable media having stored thereon instructions which, when executed by a computer, perform steps comprising:
storing quantities of a product that a user orders through an electronic commerce website in a plurality of web browsing sessions;
displaying a webpage of the electronic commerce website that has at least some information regarding the product, wherein displaying the webpage occurs in a web browsing session that takes place after the plurality of web browsing sessions;
displaying on the webpage the quantities of the product that the user ordered during the plurality of web browsing sessions, wherein the webpage includes a quantity input box in which the user can specify a quantity of the product that the user would like to order; and
displaying on the webpage a date associated with each of the plurality of web browsing sessions.

12. A non-transitory computer readable media as recited in claim 11, wherein in the web browsing session that takes place after the plurality of web browsing sessions a number supplied in the quantity input box is based on a quantity of the product that the user ordered during a most-recent one of the plurality of web browsing sessions.

13. A non-transitory computer readable media as recited in claim 11, wherein the webpage is displayed as part of a checkout process or part of a product search process.

14. A non-transitory computer readable media as recited in claim 11, further comprising displaying a user interface element on the webpage that permits the user to schedule automated recurring orders on a periodic basis.

15. A non-transitory computer readable media as recited in claim 11, wherein each of the quantities of the product that the user ordered displayed on the webpage can be selected to display information about an order associated with each of the quantities.

16. A non-transitory computer readable media as recited in claim 11, wherein the quantities displayed on the webpage are shown in a user interface element, wherein the user interface element appears as a user clicks or hovers a computer mouse over at least one of the quantity input box, a button that adds the product to an electronic cart, or an icon that indicates that the user has previously ordered the product.

17. A non-transitory computer readable media as recited in claim 16, further comprising displaying in the user interface element at least one of a bar graph, a timeline, or a statistic based on the quantities of the product that the user ordered and dates of the plurality of web browsing sessions.

18. A non-transitory computer readable media having stored thereon instructions which, when executed by a computer, perform steps comprising:
storing quantities of products that a user orders through an electronic commerce website in a plurality of web browsing sessions; and
displaying a webpage of the electronic commerce website in a web browsing session that occurs after the plurality of web browsing sessions, the webpage having the quantities of the products that the user ordered during the plurality of web browsing sessions, the webpage having at least one button capable of sorting or filtering the quantities of the products by name, by brief description, by product category, by date of order, by purchaser identity, or by SKU number.

19. A non-transitory computer readable media as recited in claim 18, further comprising displaying at least one of a graphic representing the quantities or a statistic about the quantities.

20. A non-transitory computer readable media as recited in claim 18, wherein the quantities and the at least one button are displayed in at least one of a webpage sidebar, a webpage header, a webpage footer, a webpage ribbon, a webpage identifying recently ordered products, a webpage identifying frequently ordered products, or a webpage identifying a user-defined list of products.
